(19) United States
(12) Patent Application Publication
(10) Pub. No.: US 2018/0332785 A1
(43) Pub. Date: Nov. 22, 2018

(54) STRIP CHANNEL GROWING APPARATUS AND METHOD

(71) Applicant: Hollandia Produce, L.P.

(72) Inventor: Petrus Overgaag, Carpinteria, CA (US)

(21) Appl. No.: 15/598,192

(22) Filed: May 17, 2017

(51) Int. Cl. A01G 31/02; A01G 31/04; A01G 27/00

(52) U.S. Cl. CPC A01G 31/02; A01G 2031/005; A01G 27/00; A01G 31/042

(57) ABSTRACT

An apparatus for strip growing is presented. The apparatus includes a strip unit with an open channel throughout its length that is configured to hold multiple rectangular root balls with a desired spacing between root balls. The strip unit is defined by an outer bottom wall, an outer sidewall on each side of the outer bottom wall extending upwardly and terminating in an inwardly extending peripheral lip. The open channel is defined by a skirt extending downwardly from the lip and at an angle towards the outer sidewall and terminating at an inner vertical wall, and the inner vertical wall terminating at an inner bottom wall thereby forming the open channel with its bottom section larger than its top opening. A trough unit configured for automated harvesting, and to capture and guide irrigation water down the open channel is coupled to one end of the strip unit.

### BACKGROUND OF THE INVENTION

### Field of the Invention

Embodiments of the invention relates to the field of hydroponics and container growing.

More specifically, the invention relates to a strip channel apparatus and method for growing plants with rectangular root zones.

### Description of the Related Art

Normally, hydroponic and container growing methods involve growing of multiple plants in square or round containers thereby forming root balls of similar shape. The problem with grouping more than one plant in a square or round root balls arrangement is that light does not reach all the plants evenly resulting in some yellow leaves. The yellowing becomes more pronounced when the square or round root ball plant is packaged and placed in a store display.

Also, the advantage of hydroponic and container growing and packaging of live plants is that one can have fresh and live vegetables up to the time of use. However, since these plants still have their roots and root balls when the package is opened in the kitchen, one would have to separate the root balls from the leaves. This process of separating the root balls from the leaves would sometimes leave unpalatable mess around the food. In some cases, parts of the root balls may even mix with the leaves.

To overcome the problems and limitations described above there is a need for a packaging and growing method that assures that all the plants receive approximately the same amount of light and alleviates the unpalatable mess when separating leaves from the root balls.

### BRIEF SUMMARY OF THE INVENTION

One or more embodiments of the invention are directed a strip channel apparatus and method for growing plants with rectangular root zones. The invention comprises a strip unit with an open channel throughout its length. The open channel is configured to hold one or more rectangular root balls with a desired spacing between root balls.

In one or more embodiments, the strip unit comprises an outer bottom wall with an outer sidewall on each side of the outer bottom wall. Each outer sidewall extending upwardly and terminating in an inwardly extending peripheral lip that is about one quarter the width of the outer bottom wall.

In one or more embodiments, a hollow tube is coupled to each side of the bottom side of the outer bottom wall. The hollow tubes run the length of the strip unit and add structural strength to the system. The hollow tubes may also serve other purposes, e.g. coupling multiple units, etc.

In one or more embodiments, the open channel is defined by a skirt extending downwardly from the lip at an angle towards the outer sidewall and terminating at an inner vertical wall that extends to approximately one-third of the height of the outer sidewall from the outer bottom wall. The inner vertical wall terminates at an inner bottom wall thereby forming the open channel with a bottom section larger than its top opening. The larger bottom section of the channel provides for substantially unobstructed flow of irrigation water down the channel. The wide bottom provides enough space for irrigation water to flow alongside the root ball and the inside angle of the top skirt keeps the plant from falling over, and the pinching together of the lips functions to block sunlight from the root zone.

In one or more embodiments, a trough unit is coupled to the strip unit through a lumen in the strip unit. The lumen is formed between the outer walls and the inner walls. The trough unit comprises a proximal section that is configured to capture irrigation water from a dripper mounted above the trough unit and to guide the water down the open channel.

In one or more embodiments, the trough unit further comprises a plurality of fences in the proximal section. Each one of the plurality of fences is sloped from approximately the bottom wall of the trough unit to a top edge of a back wall of the trough unit.

### BRIEF DESCRIPTION OF THE DRAWINGS

The above and other aspects, features and advantages of the invention will be more apparent from the following more particular description thereof, presented in conjunction with the following drawings wherein:

FIG. 1 is an illustration of an isometric view of a live plant packaging container in a closed position in accordance with one or more embodiments of the present invention.

FIG. 2 is an illustration of a left side plan view of the live plant packaging container in a closed position in accordance with one or more embodiments of the present invention.

FIG. 3 is an illustration of a top plan view of the live plant packaging container in a closed position in accordance with one or more embodiments of the present invention.

FIG. 4 is an illustration of an isometric view of the live plant packaging container with the covers opened in accordance with one or more embodiments of the present invention.

FIG. 5 is an illustration of a left side plan view of the live plant packaging container with the covers opened in accordance with one or more embodiments of the present invention.

FIG. 6 is an illustration of a top plan view of the live plant packaging container with the covers opened in accordance with one or more embodiments of the present invention.

FIG. 7 is an illustration of a front plan view of the live plant packaging container with the covers closed in accordance with one or more embodiments of the present invention.

FIG. 8 is an illustration of an isometric view of the live plant packaging container with the leaf compartment and the root ball compartment lids in a partially opened position in accordance with one or more embodiments of the present invention.

FIG. 9 is an illustration of an isometric view of the live plant packaging container with the leaf compartment lid in a partially opened position and the root ball compartment lid in a closed position in accordance with one or more embodiments of the present invention.

FIG. 10 is a flowchart illustrating the hydroponics growing process for strip root plant in accordance with one or more embodiments of the present invention.

FIG. 11 is an illustration of the strip trays with growing media and plants in accordance with one or more embodiments of the present invention.

FIGS. 12A and B are illustrations of a harvested strip root plant in accordance with one or more embodiments of the present invention.

FIG. 13 is an illustration of a strip channel system for growing plants with rectangular root zones in accordance with one or more embodiments of the present invention.

FIG. 14A is a perspective view of the strip unit of the strip channel system in accordance with one or more embodiments of the present invention.

FIG. 14B is an end view of the strip unit of the strip channel system in accordance with one or more embodiments of the present invention.

FIG. 15 is a perspective view of an end trough of the strip channel system in accordance with one or more embodiments of the present invention.

FIG. 16 is an illustration of an end view of the strip channel system with a plant in accordance with one or more embodiments of the present invention.

### DETAILED DESCRIPTION

The present invention comprising a strip channel apparatus and method for growing plants with rectangular root zones will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

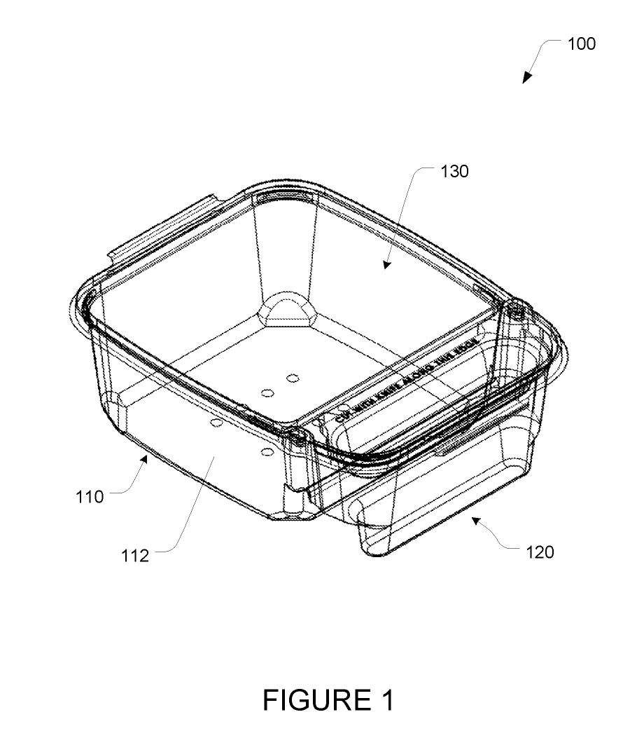

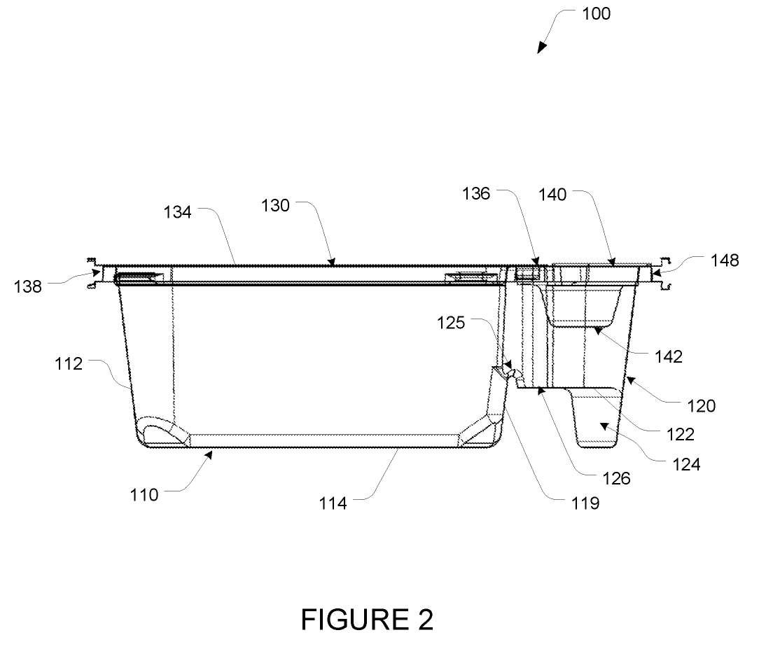

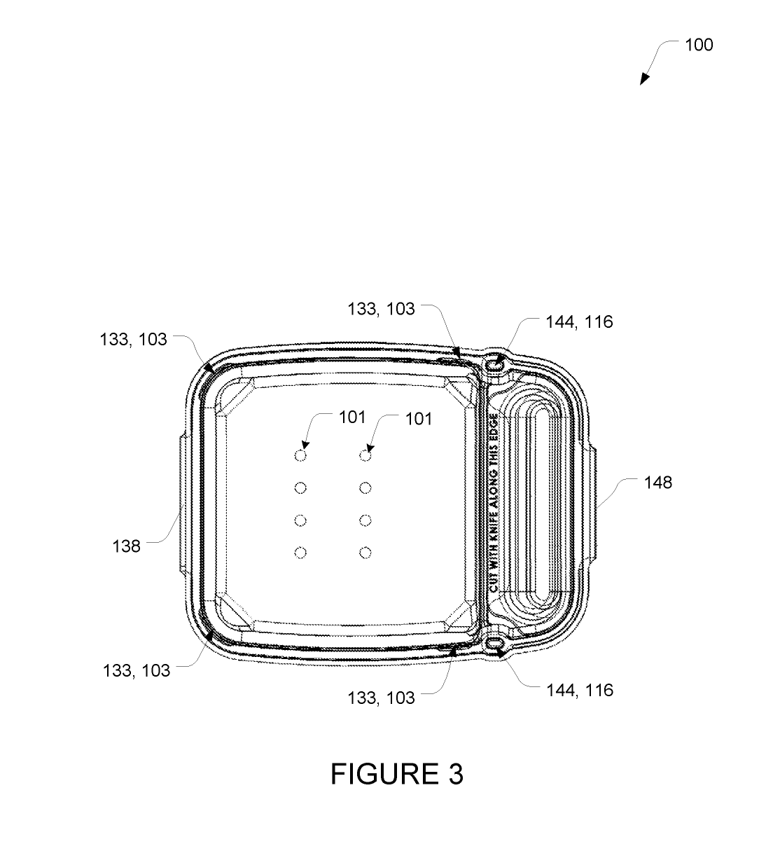

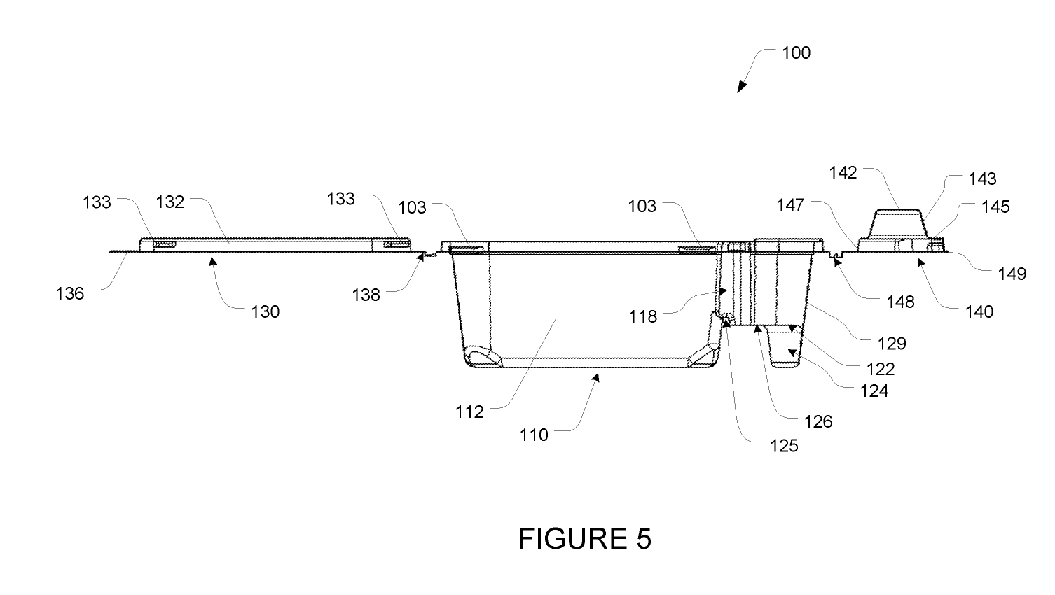

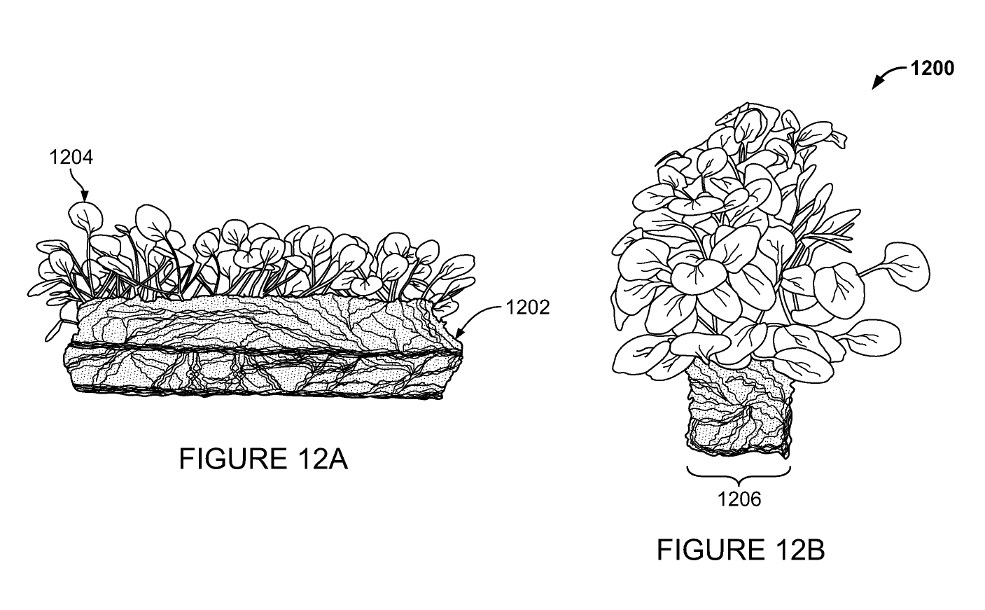

One or more embodiments of the present invention will now be described with references to FIGS. 1-12.

### Packaging Container:

Referring more particularly to FIGS. 1-9, a container 100 is presented. The container 100 is preferably thermoformed thermoplastic clamshell which is molded from a single sheet of thermoplastic material. Container 100 comprises a base section with a leaf (or first) compartment 110 and a root ball (or second) compartment 120. In one or more embodiments, container 100 further comprises a first lid 130, which is connected to the leaf compartment 110, and pivots about a hinge 138 between a position which covers the leaf compartment 110 and one which uncovers the leaf compartment 110. Container 100 further comprises second lid 140, which is connected to the root ball compartment 120, and pivots about a hinge 148 between a position which covers the root ball compartment 120 and one which uncovers the root ball compartment 120. Those of skill in the art would appreciate that although first lid 130 and second lid 140 are illustrated to be pivotally engaged to leaf compartment 110 and root ball compartment 120, respectively, other configurations are contemplated. For instance, either or both first lid 130 and second lid 140 may be configured as separate parts that are not integrally formed or connected with the base section when open.

In one or more embodiments, the sheet of thermoplastic material from which the container 100 is formed is preferably coextruded of transparent material in the regions defining the first lid 130. The regions defining the leaf compartment 110, the root ball compartment 120 and second lid 140 may generally comprise opaque or semi-opaque material. Those of skill in the art would appreciate that embodiments with the entire container 100 comprising transparent material is also contemplated and that the choice of transparency depends on desire for ornamentation and aesthetic.

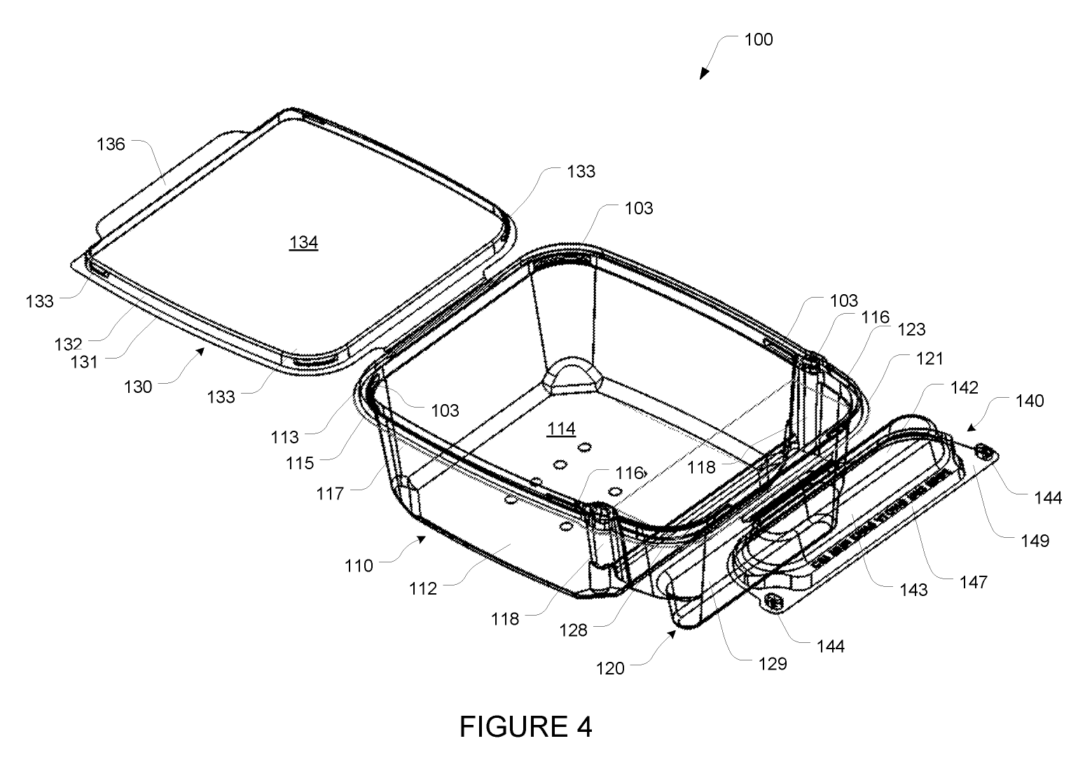

As better seen in FIG. 4, the leaf compartment 110 has a bottom wall 114 from which a sidewall 112 extends upwardly therefrom, leaving a substantially open end at the connection with root ball compartment 120, and terminating in an outwardly extending peripheral lip 113. Sidewall 112 is coupled to a support post 118 at each open end. A skirt 115 extends downwardly from the lip 113, and a generally horizontal peripheral flange 117 extends outwardly from the skirt. In one or more embodiments, hinge 138 is coupled to peripheral flange 117 on leaf compartment 110 and flange 131 on first lid 130. In one or more embodiments, the height of the leaf compartment is approximately three inches. Of course, other heights are contemplated thus the chosen height for the container would depend on the application.

Each side of the open end of leaf compartment 110 is coupled to a support structure 118. The general outline of the leaf compartment 110 and the sidewall 112 is preferably configured for stiffness. For instance, the general outline may be other than strictly rectangular, e.g. some form of a closed curved shape. The peripheral flange 117 extends outwardly from the skirt 115 a uniform amount for most of the periphery around leaf compartment 110.

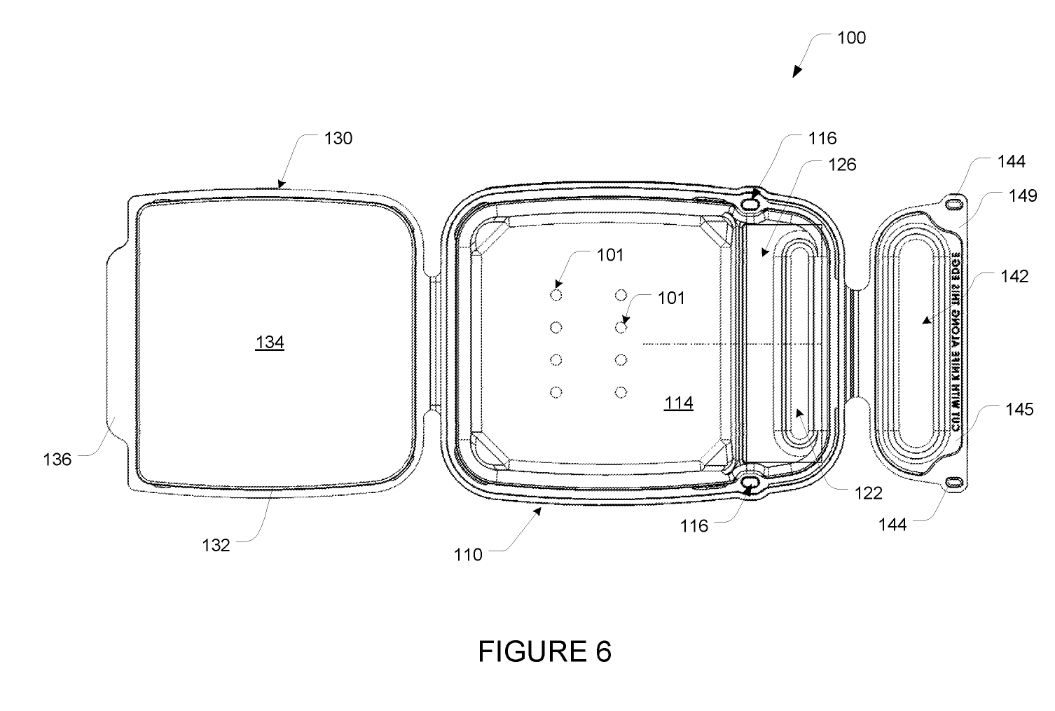

In one or more embodiments, each support post 118 runs from top of sidewall 112 and extends downwardly to approximately two-thirds the height of sidewall 112 and includes a groove 116 at the top. The leaf compartment 110 further comprises a sidewall 119 on the open side, extending upwardly from bottom wall 114 and terminating in an outwardly extending ridge 125 at the base of support structure 118. Sidewall 119 extends to approximately one-third to midway the height of sidewall 112 and is coupled to the bottom section of sidewall 112 to complete the space comprising the leaf compartment 110. As better illustrated in FIG. 6, ridge 125 is configured such that a knife's blade could be run down its edge on the leaf compartment side to cut and separate the leaves from the roots. As further discussed below, the knife is used to cut and separate the root ball 1202 from the leaves 1204, with second lid 140 in a closed position.

Since the leaf compartment 110 is configured to contain the leaves of a live plant, the bottom wall 114 comprises one or more holes 101 for ventilation and drainage. Those of skill in the art would appreciate that the number and placement of the ventilation and drainage holes 101 in leaf compartment 110 could be modified from that illustrated without deviating from the invention. For instance, embodiments without ventilation/drain holes are also contemplated, and embodiments with the ventilation/drain holes on the sidewall 112 or on the top wall 134 of the first lid 130 are also contemplated. In an exemplary usage, the ventilation/drain holes 101 may be covered with a label that can be peeled back so that the leaves can be rinsed in the package.

In one or more embodiments, the first lid 130 has a bottom wall 134 from which a sidewall 132 extends upwardly therefrom. The sidewall 132 terminates in an outwardly extending peripheral and horizontal flange 131. The general outline of sidewall 132 is such that when first lid 130 is pressed down on the top of leaf compartment 110 it is retained in the closed position in a snap fit with the peripheral flange 131 extending over lip 113 of leaf compartment 110.

First lid 130 further comprises a tab 136 which is configured to partially overlay second lid 140, when closed, and serve as a handle for separating first lid 130 from leaf compartment 110. First lid 130 further comprises one or more tongue tabs 133 located on the periphery of sidewall 132. As illustrated, there is preferably one tongue tab 133 at each corner of first lid 130.

In one or more embodiments, leaf compartment 110 further comprises one or more grooves 103 for securing the first lid 130 to the container leaf compartment body 110 using tongue-and-groove lock components 133 and 103. Thus, as illustrated, for each tongue tab 133 on first lid 130, there is a corresponding groove 103 in leaf compartment 110. Those of skill in the art would appreciate that other configurations for locking the first lid to leaf compartment 110 are contemplated. For instance, the tongue-and-groove lock components 133 and 103 may vary and may be switched such that the tongue is on the leaf compartment body 110 while the groove is on the first lid 130.

In one or more embodiments, root ball compartment 120 comprises a bottom wall 126 that extends outwardly from the bottom of ridge 125, thereby coupling the leaf compartment 110 with the root ball compartment 120. The bottom wall 126 comprises a first section and a second section. The first section is closest to the open end of leaf compartment, i.e. the end that is closest to ridge 125, and is configured as a tabletop to hold the root ball 1202 of a live plant 1200. The second section, which is the end farthest from ridge 125, includes a hole 122 abutting sidewall 129. Sidewall 129 of root ball compartment 120 extends upwardly from bottom wall 126, and terminates in an outwardly extending peripheral lip 123. A skirt 128 extends downwardly from the lip 123, and a generally horizontal peripheral flange 121 extends outwardly from the skirt 128. Sidewall 129 couples to the open end of leaf compartment 110 at support post 118 thereby forming one contiguous base unit. In one or more embodiments, hinge 148 is coupled to peripheral flange 121 on root ball compartment 120 and flange 149 on second lid 140.

In one or more embodiments, flange 117 and flange 121 are connected at support posts 118 thereby forming a single unit that runs the entire periphery of the base unit. As discussed above, because the root ball compartment 120 is configured for containment of the roots of a live plant 1200, the bottom wall 126 serves to hold the root ball 1202 of the live plant while ridge 125 provides horizontal support and restricts sliding of the root ball.

Root ball compartment 120 further comprises a nutrient holding section 124 coupled to the bottom wall 126 at hole 122. Nutrient holding section 124 is configured as a bucket that extends downwardly from the bottom wall 126 to approximately the same plane as the bottom wall 114 of leaf compartment 110.

In one or more embodiments, second lid 140 comprises a bottom wall 142 from which a sidewall 143 extends upwardly therefrom, and terminating in an outwardly extending peripheral and horizontal section 145. A skirt 147 extends upwardly from the horizontal section 145, and a generally horizontal peripheral flange 149 extends outwardly from the skirt 147. The general outline of skirt 147 is such that when second lid 140 is pressed down on the top of root ball compartment 120 it is retained in the closed position in a snug fit with its peripheral flange 149 extending over lip 123 of root ball compartment 120. Thus, the shape of the periphery of skirt 147 is configured to approximate the shape of the inside top lip of root ball compartment 120. The sheet of thermoplastic material from which the second lid 140 is formed is preferably coextruded of transparent material in the regions defining the bottom wall 142 to provide a window for viewing the root ball.

As illustrated, second lid 140 further comprises one or more tongue tabs 144 located on the inside top corners of flange 149 for securing the second lid 140 to the container root ball compartment body 120 using tongue-and-groove lock components 144 and 116. Thus, there is a corresponding tongue tab 144 on lid 140 for a groove 116 in support structure 118. Those of skill in the art would appreciate that other configurations for locking the second lid 140 to root ball compartment 120 are contemplated. For instance, the tongue-and-groove lock components 144 and 116 may vary and may be switched such that the tongue is on the root ball compartment body 120 while the groove is on the second lid 140.

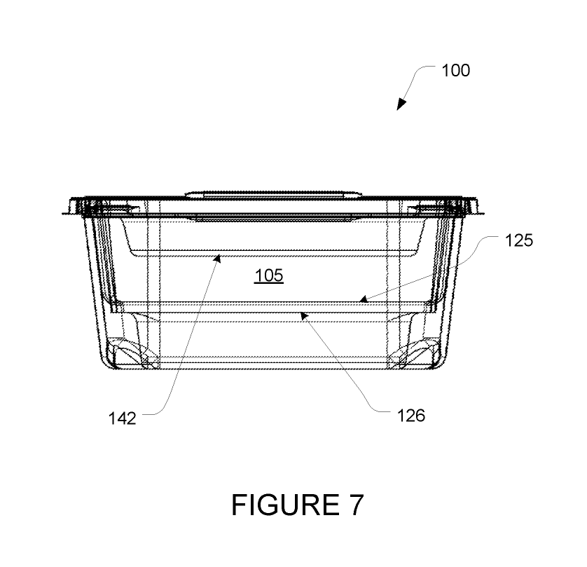

Bottom wall 142 is configured to be approximately one-third of the height of the leaf compartment down from the top of root ball compartment 120 and acts together with the bottom wall 142 to clamp and retain the root ball 1202 of live plant 1200. As illustrated in FIG. 7, when the second lid 140 is closed, the bottom wall 142 of the second lid 140 and the bottom wall 126 of the root ball compartment 120 together form opposite sides of a rectangular channel 105 for housing the root ball 1202 of the live plant 1200. The height of channel 105 is configured to be approximately the width 1206 of root ball 1202. Preferably, the channel 105 snugly maintains the root ball in place by the second lid clamping the root ball down to the bottom wall 142.

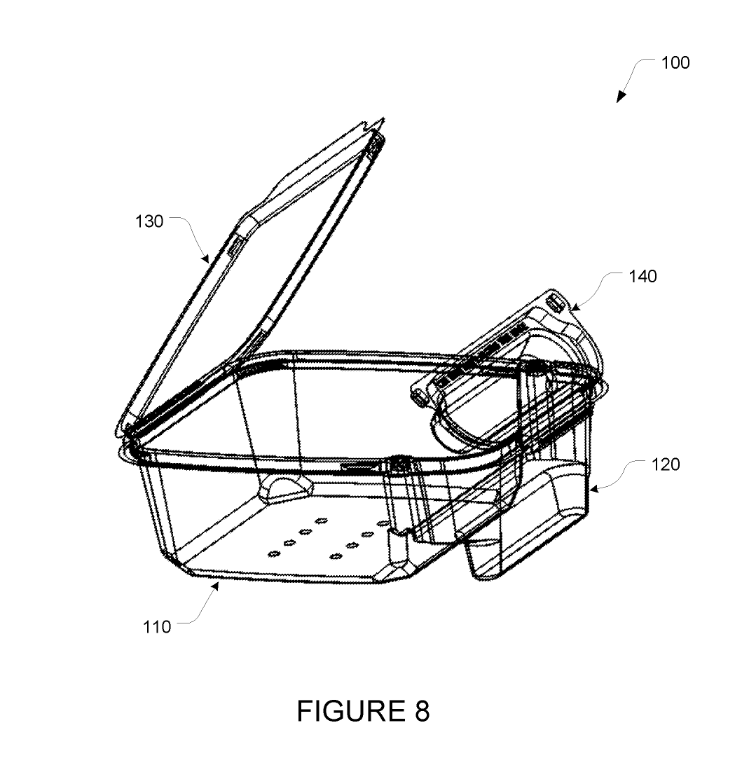

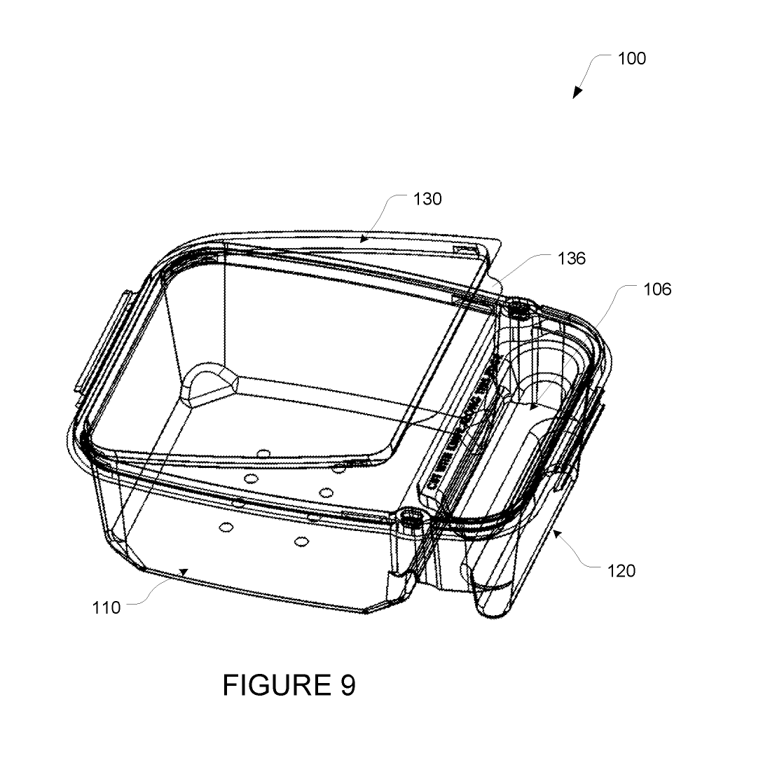

As illustrated in FIGS. 8 and 9, the closing sequence for the first and second lids of container 100 is such that second lid 140 is closed first and locked into place with tongue and groove components 144 and 116, followed by first lid 130, with tab 136 partially overlying the deep and wide clamping groove 106 on second lid 140. The deep and wide clamping groove 106 is formed by the flat bottom wall 142, sidewall 143 and skirt 147 on the second lid 140. The space identified by clamping groove 106 is configured to facilitate a user grabbing tab 136 in order to pull open first lid 130. For example, with a live plant 1200 in the container 100, the first lid 130 may be pulled open by the tab 136, and then to separate the root ball 1202 from the leaves 1204, the blade of a knife can be run across the length of the ridge 125. By cutting the root ball while the second lid 140 is closed, debris from the root ball is contained in root ball compartment 120.

### Strip Growing:

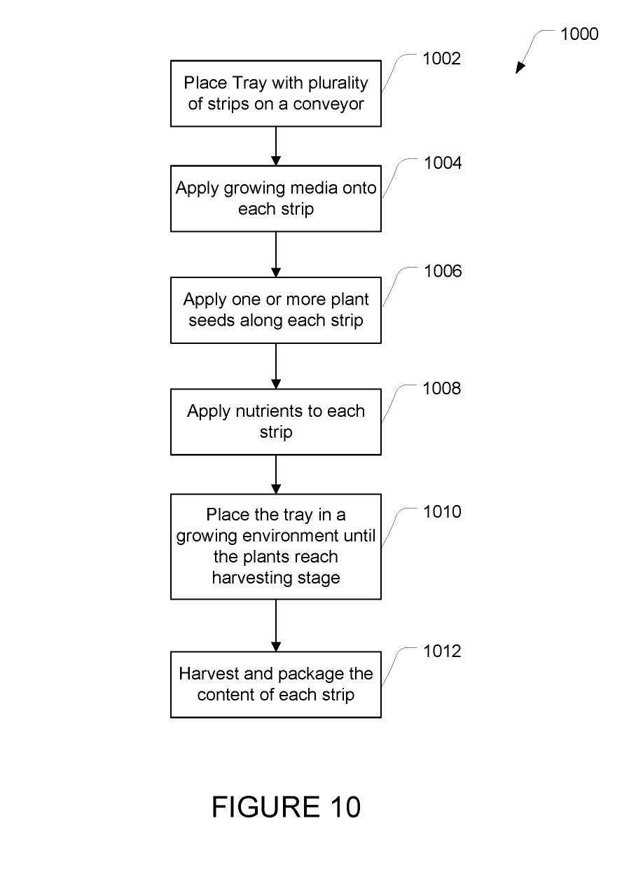

Strip growing of live plants of the present invention provides an added advantage that the leaves are exposed to substantially the same amount of light, e.g. sunlight, artificial light, etc., thus reducing incidences of yellow leaves that are prevalent in current growing and distribution methods for live vegetables such as butter lettuce, upland cress, and other greens. The strip growing process described herein results in better vegetable yield per square foot of planting. One or more embodiments of the strip growing process is illustrated using FIGS. 10-12.

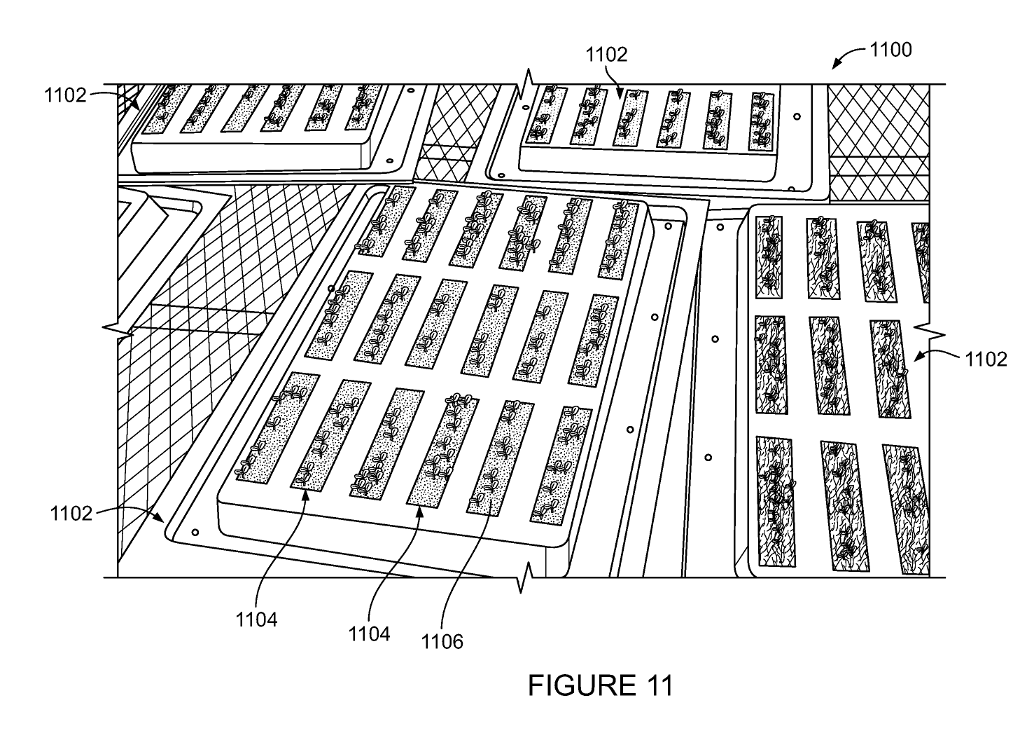

As illustrated in FIG. 10, the strip growing process begins at station 1002 by placing one or more trays with strip grooves on a conveyor belt or similar system. Trays 1102 with strip grooves, e.g. 1104, are illustrated in FIG. 11. Each strip is approximately 1.0 inch in width and is preferably between about 0.5 inches to about 1.5 inches in width. The length of the strip is preferably between 3.0 inches and 9.0 inches. One of skill in the art would appreciate that narrower or wider width and/or longer length strips are also contemplated.

As the conveyor moves the tray 1102 to a next station 1004, growing media, e.g. 1106, is applied into the strip grooves 1104. Examples of growing media 1106 for hydroponic and container growing include coco fiber, rock wool fiber, Peat Moss, etc.

At station 1006, plant seeds are applied in substantially a single row along the longitudinal axis or randomly sprinkled on the surface of the growing media 1106 in strip groove 1104. At station 1008, nutrients are applied to the growing media in each strip groove; and at station 1010, each tray 1102 is placed in a growing environment until the plants, e.g. 1106, reach harvesting stage. An exemplary growing environment comprises strip channel system 1300 and a greenhouse, shade house and/or outdoor.

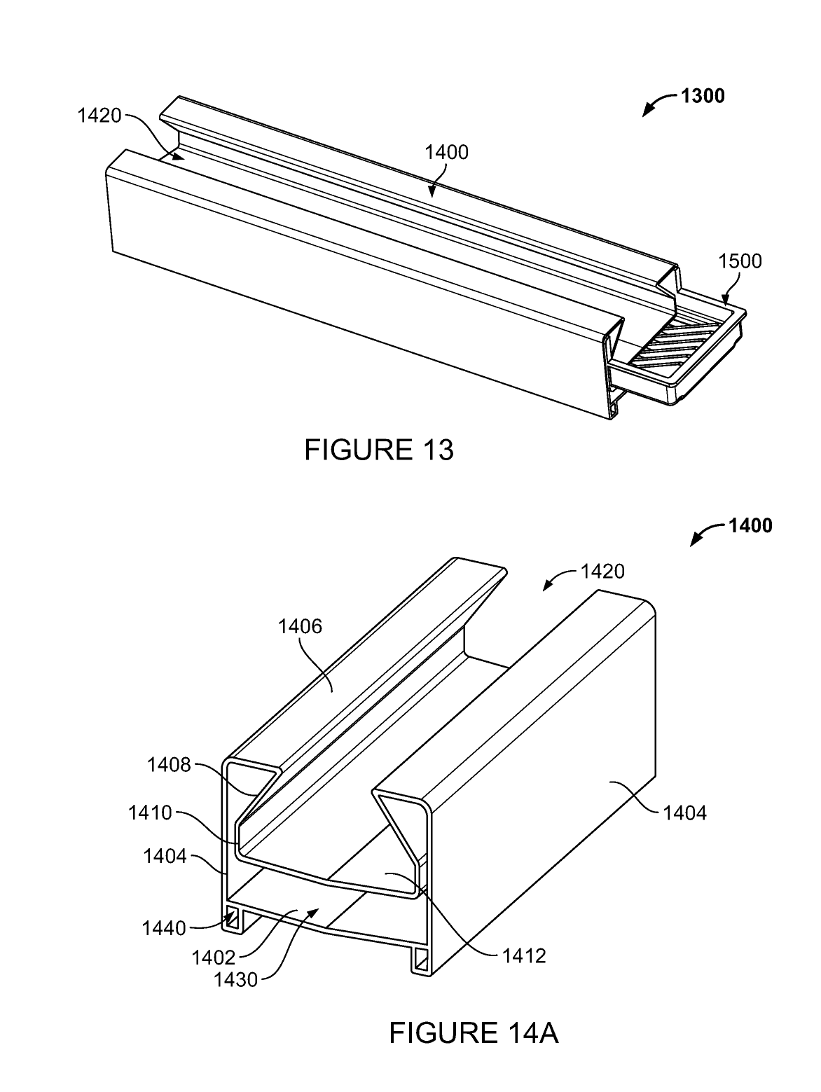

FIG. 13 is an illustration of a strip channel apparatus 1300 for growing plants with rectangular root zones in accordance with one or more embodiments of the present invention. As illustrated, the strip channel growing apparatus comprises strip component (unit) 1400 and end trough component 1500. Channel 1420 in strip component 1400 is configured to hold one or more rectangular root balls, e.g. 1202. The channel 1420 is open and runs the length of the strip component to allow for any desired spacing between rectangular root balls and to allow for multiple (i.e. plurality) root balls 1202. Thus, the open channel, 1420, allows for flexibility in spacing between root balls.

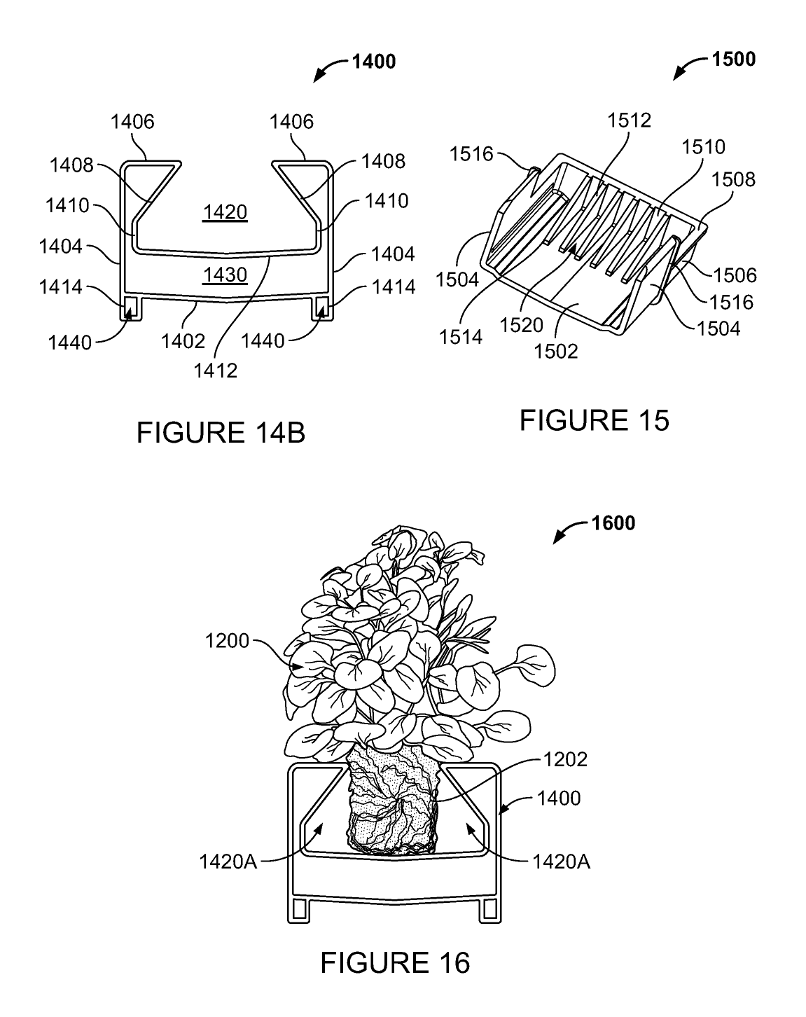

FIGS. 14A and 14B are views of the strip component 1400 in accordance with one or more embodiments of the present invention. As illustrated, strip component 1400 comprises an outer bottom wall 1402 from which outer sidewall 1404 extends upwardly therefrom on each side of the outer bottom wall 1402, and terminating in an inwardly extending peripheral lip 1406 that is about one quarter the width of the outer bottom wall. The channel 1420, on the topside of the strip, is formed by a skirt 1408 which extends downwardly from the lip 1406, at an inside angle towards the sidewall 1404 and terminating at an inner vertical wall 1410 that extends to approximately one-third of the height of the sidewall 1404 from the bottom wall 1402. The inner vertical wall 1410 terminates at an inner bottom wall 1412 thereby forming the bottom wall of channel 1420, which is shaped as an inverted teacup (or irregular hexagon), that is, the bottom section is substantially wider than the top section. The wide bottom provides enough space, e.g. 1420A, for irrigation water to flow alongside the root ball, as illustrated in FIG. 16. In addition, the inside angle of the top skirt 1408 keeps the plant 1200 from falling over, and the pinching together of the lips 1406 functions to block sunlight from the root zone. With the above described configuration of walls, an internal space (lumen) 1430 is formed between the inner walls and the outer walls of the strip unit. In a preferred embodiment, strip 1400 is substantially a cuboid or rectangular prism in its outside perimeter and formed of an opaque and sturdy material, such as thermoplastic, composite, etc.

In one or more embodiments, strip unit 1400 further comprises a hollow tube 1414, e.g. with lumen 1440, coupled on each side of the outer bottom wall 1402, to function as legs. The hollow tubes run the length of the strip unit 1400 and add structural strength to the system. The lumen 1440 may be used for different purposes such as coupling the apparatus to other systems, coupling a plurality of strip components 1400, securing the apparatus, etc.

FIG. 15 is a perspective view of an end trough 1500 of the strip growing channel apparatus in accordance with one or more embodiments of the present invention. As illustrated in FIG. 13, end trough unit 1500 is configured to be coupled to one end of strip unit 1400, via internal space (orifice) 1430. Trough 1500 is a cup-like device configured to capture irrigation water from a dripper (not shown) that is mounted above the trough unit, and to guide the water down the channel 1420. End trough 1500 is preferably uniquely configured to couple with strip component (unit) 1400 through internal space 1430.

As illustrated in FIG. 15, end trough 1500 comprises a proximal section 1530 that is exposed when coupled with strip unit 1400 and a distal section 1540 that fits into orifice 1430 for coupling the trough 1500 to the strip unit 1400. Proximal section 1530 and distal section 1540 are coupled by a bottom wall 1502. A front sidewall 1504 is coupled to each side of the distal section of bottom wall 1502 and extends upwardly therefrom. Front sidewall 1504 begins at the front end of bottom wall 1502 and runs lengthwise for the distance of the distal section 1540, which is approximately midway the length of the bottom wall 1502. The back end of front sidewall 1504 terminates in an outwardly extending stop 1516 which serves as an insertion limit stop for trough 1500 when inserted into lumen 1430.

The proximal section 1530 includes a rear sidewall 1506 that is coupled to each side of the proximal section of bottom wall 1502 and extends upwardly therefrom, terminating in an outwardly extending flange 1508. Rear sidewall 1506 begins at the end of front sidewall 1504 and runs lengthwise to the back of the bottom wall 1502 and terminating at back wall 1510.

Back wall 1510 extends upward from bottom wall 1502 and terminates at the outwardly extending flange 1508, which runs the entire top of rear sidewall 1506 and back wall 1510. The height of back wall 1510 and rear sidewall 1506 is approximately the height of inner vertical wall 1410 such that when end trough 1500 is inserted into lumen 1430, inner vertical wall 1410 and rear sidewall 1506 would seem like a contiguous unit, as illustrated in FIG. 13.

Inside trough 1500 is a plurality of parallel fences 1512 running the length of the proximal section 1530. Each fence begins at the boundary of the proximal and distal sections with a height that is approximately the level of the top surface of the bottom wall 1412 of strip unit 1400—when the two components are coupled together, is angled upward to the top of back wall 1510. The gutters formed between the fences act to capture and guide drip irrigation water down the channel 1420.

In one or more embodiments, the plurality (e.g. six in the illustration) of angled fences 1512 is configured to facilitate automatic plant harvesting. For instance, plants can be pushed out from the channel 1420 towards the end trough unit 1500, and because the fences slope from low to high, i.e. from bottom wall 1412 to top of back wall 1510, the plants simply slide up the fences and then are picked up by an automated picker. Thus, a combination of the open channel 1420 and the configuration of the end trough 1500 provides for higher speed automated harvesting.

After the plants reach harvesting stage, at station 1012, each plant is harvested, e.g. 1200, and packaged in container, e.g. 100, for distribution. As discussed above, packaging with container 100 comprises placing the plant with its root ball entirely in the root ball compartment 120 and the leaves in the leaf compartment 110. Container 100 may include additional nutrients in nutrient holding section 124 to keep the plant 1200 living until ready for consumption, typically a few days or weeks. Those of skill in the art would appreciate that other type packaging containers are contemplated so long as the container is suitable for display and to provide nutrient and light to sustain the live plant. For instance, the container could be a bag specially configured for such purposes.

While the invention herein disclosed has been described by means of specific embodiments and applications thereof, numerous modifications and variations could be made thereto by those skilled in the art without departing from the scope of the invention set forth in the claims.

What is claimed is:

1. An apparatus for strip growing of plants comprising:
a strip unit with an open channel throughout its length and a coupling lumen, wherein the open channel is configured to hold one or more rectangular root balls with a desired spacing between root balls; and
a trough unit coupled to said strip unit through said lumen, wherein said trough unit comprises a proximal section that is configured to capture irrigation water from a dripper mounted above the trough unit and to guide the water down the open channel.

2. The apparatus of claim 1, wherein said strip unit comprises an outer bottom wall, an outer sidewall on each side of the outer bottom wall and extending upwardly and terminating in an inwardly extending peripheral lip that is about one quarter the width of the outer bottom wall.

3. The apparatus of claim 2, wherein the open channel is defined by a skirt extending downwardly from the lip at an angle towards the outer sidewall and terminating at an inner vertical wall that extends to approximately one-third of the height of the outer sidewall from the outer bottom wall, with the inner vertical wall terminating at an inner bottom wall thereby forming a channel having a bottom section larger than its top opening, wherein the larger bottom section provides for substantially unobstructed flow of irrigation water.

4. The apparatus of claim 1, wherein the trough unit further comprises a plurality of fences in the proximal section, wherein each one of the plurality of fences is sloped from approximately the bottom wall of the trough unit to a top edge of a back wall of the trough unit.

5. The apparatus of claim 1, wherein said strip unit further comprises a hollow tube coupled on each side of the outer bottom wall to function as legs.

6. An apparatus for strip growing of plants comprising:
a strip unit with an open channel on its topside that runs throughout its length, wherein the open channel is configured to hold one or more rectangular root balls with a desired spacing between consecutive root balls, wherein the open channel comprises a pinched-in lip on top with a skirt that slopes away from center of the channel and a larger bottom section; and
a trough unit coupled to one end of said strip unit, wherein said trough unit comprises a proximal section that is configured to capture irrigation water from a dripper mounted above the trough unit and to guide the water down the open channel.

7. The apparatus of claim 6, wherein the trough unit further comprises a plurality of fences in the proximal section, wherein each one of the plurality of fences is sloped from approximately the bottom wall of the trough unit to a top edge of a back wall of the trough unit.

8. The apparatus of claim 6, wherein said strip unit further comprises a hollow tube coupled on each side of the outer bottom wall to function as legs.

9. The apparatus of claim 6, wherein the pinched-in opening is approximately the width of a root ball.
